(19) United States
(12) Patent Application Publication
(10) Pub. No.: US 2011/0302750 A1
(43) Pub. Date: Dec. 15, 2011

(54) No Tools Quick Assembly Surface Fastening System

(75) Inventor: John M. Green, East Otto, NY (US)

(73) Assignee: BUSH INDUSTRIES, INC., Jamestown, NY (US)

(21) Appl. No.: 12/814,970

(22) Filed: Jun. 14, 2010

(51) Int. Cl. F16B 2/02; B23P 19/00

(52) U.S. Cl. 24/457; 29/525.02

(57) ABSTRACT

A quick assembly surface fastening system for mounting accessories to a desk or another type of support member, without requiring a separate tool, is provided. The fastening system includes an adjustable clamping device for frictionally engaging an edge of a desk; a clamp nut assembly having a tightening member pivotally attached thereto and adapted for pivoting between a first and second position; and an accessory sleeve configured for mounting upon the clamp nut assembly. The tightening member pivots between the first position to function as a tool for adjusting the clamping device to bring the clamping device into frictional engagement with the support member. The tightening member pivots to the second position where at least a portion of the clamp nut assembly including the tightening member is configured for receiving the accessory sleeve. A method for mounting an accessory to a support member is also provided.

### BACKGROUND OF THE INVENTION

1. Field of the Invention

The present invention relates generally to a fastening system for mounting an accessory and, more particularly, to a no tools quick assembly surface fastening system for mounting an accessory to a support member, such as a desk.

2. Description of Related Art

Clamping systems for securing accessories to the edge portion of a desk typically comprise a plurality of separable components and require one or more tools to assemble and secure the components to the desk. Access to these components may occur at difficult to reach locations, i.e., behind the desk and adjacent to a wall surface and/or underneath a desk surface, requiring one to move the desk or crawl underneath the desk to attach and/or detach the device.

U.S. Pat. No. 5,938,158 to Tisbo teaches an example of a desktop support structure which does not require separate assembly tools. The support structure comprises an upright structural housing having an adjustable clamp portion which positions the housing in an upright position in relation to a desktop and an adjustable securement portion for aligning an attachment socket to a slat wall structure support member. The adjustable clamp portion is coupled to a threaded bolt and raised and lowered in relation to the nut securement area. To position the device, the structural housing is opened by first rotating the housing while the adjustable clamp portion is held in a fixed position, allowing the thread shaft to rotate through the securement nut causing the spatial distance between the clamp and the end cap to be enlarged. Once the clamp area is enlarged, the clamp is placed over the edge of the desk and held in a fixed position while the structural housing is rotating so as to cause closure between the engagement surface supports.

U.S. Pat. No. 6,299,117 to Lin also teaches a clamping device which does not require separate assembly tools comprising a base with a clamp that includes a clamping barrel, a fixing bolt, a sleeve seat, and a clamping plate. The clamping barrel is provided with an open bottom and has an upper plate with a central top hole. The clamping barrel is provided with an open bottom and has an upper plate with a central top hole. The clamping barrel at the periphery of the main body thereof can be provided with a barrel groove for exerting a force. The fixing bolt is composed of a clamping rod and a fastening plate. The fastening plate has a fastening post for joining to an extension bar of a stand or a support frame for articles. The clamping plate is configured to span two lateral sides of a circular hole of a desktop. In use, the sleeve seat is placed on a held object, such as the circular hole of the desktop. Next the clamping barrel and the clamping bolt are fitted to a cylindrical ring of the sleeve seat and the clamping plate is placed under the circular hole. The clamping barrel is then turned along with the rod threads of the clamping rod such that the clamping rod moves upward to clamp the desktop by way of two contact edges and a base disk.

There is a need in the art for a quick assembly fastening system for mounting an accessory to a support member which does not require tools, utilizes a minimum of separable components and is easy to attach, access, and manipulate from above the surface of the support member.

### SUMMARY OF THE INVENTION

The present invention is directed to a no tools quick assembly surface fastening system for mounting accessories, such as lamps, dividers, shelves, and the like to a desk or another type of support member.

According to one aspect, the invention is directed to an accessory mounting system comprising an adjustable clamping device for frictionally engaging an edge of a support member; a clamp nut assembly associated with the clamping device wherein the clamp nut assembly includes a tightening member pivotally attached thereto and adapted for pivoting between a first and second position; and an accessory sleeve configured for mounting upon the clamp nut assembly. The tightening member pivots between the first position to function as a tool for adjusting the clamping device from a location above the support member such that the clamping device comes into frictional engagement with the support member. The tightening member pivots to the second position where at least a portion of the clamp nut assembly including the tightening member is configured for receiving the accessory sleeve. The adjustable clamping device comprises a foot base, a first rod extending from a surface of the foot base, a top clamp having at least a first aperture extending therethrough. The first aperture is configured for receiving the first rod, and the clamp nut assembly is configured for cooperating with the first rod to form an adjustable gap between the foot base and the top clamp. The adjustable gap is configured for receiving the edge of the support member for mounting the clamping device thereon. According to one embodiment, the clamping device can include a longitudinal member and the tightening member can form a T-shape with respect to the longitudinal member when in the first position for tightening the clamp. When in the second position, the tightening member can be aligned with the longitudinal member enabling receipt of the accessory sleeve thereon. The accessory sleeve can comprise a longitudinal member having a first end and a second end wherein the first end includes a gap for receiving at least a portion of the tightening member and/or longitudinal member of the clamp nut assembly when the tightening member is in the second position. The second end of the accessory sleeve can include a mounting member configured for holding the accessory. The accessory can be a lamp, a divider, a panel, a computer monitor, a shelf, and the like. According to one embodiment, the longitudinal member of the clamp nut assembly can include an opening for receiving the pivotal member when the pivotal member is in the second position such that the tightening member has a planar or cylindrical surface with respect to the longitudinal member.

According to another aspect, the invention is directed to a fastening system for securing an accessory to a support member wherein the support member has a top surface, an end portion, and a bottom surface. The fastening system comprises a clamping device comprising foot base; a first rod extending from a surface of the foot base; a top clamp having a top surface and a bottom surface wherein the top clamp includes at least a first aperture extending therethrough wherein the first aperture is configured for receiving the first rod. The fastening system further includes a clamp nut assembly configured for cooperating with the first rod to form an adjustable gap between the foot base and the top clamp. The adjustable opening is configured for receiving the support member. The clamp nut assembly further includes a tightening member adapted for pivoting between a first position and a second position wherein, when in the first position, the pivotal member allows for adjustment of the gap between the foot base and the top clamp such that the top clamp frictionally engages the top surface of the support member and the foot base frictionally engages the bottom surface of the support member. The fastening system further includes an accessory sleeve having a first end configured for cooperation with the clamp nut assembly and a second end configured for holding or mounting the accessory. According to one embodiment, the foot base includes a second rod extending from the surface thereof in a spaced relationship with respect to the first rod. The first rod can include threads and the clamp nut assembly can include a threaded tubular portion for threadedly engaging the first rod. According to one embodiment, the clamp nut assembly can comprise a longitudinal member and the tightening member is pivotally attached to the longitudinal member. The tightening member can pivot to a first position extending in a transverse direction with respect to the longitudinal member to enable tightening of the clamp nut assembly from above the support surface and without a separate tool. After tightening, the tightening member can pivot to a second position in line with the longitudinal member enabling receipt of the accessory sleeve onto the tightening member and/or the longitudinal member. According to one embodiment, the longitudinal member can include an opening for receiving the tightening member when the tightening member is in the second position. A cover plate can be provided to cover at least one side of the opening extending between the foot base and the top clamp, such as the back opening, so that from the rear, the first threaded rod and the second rod are not visible to produce an aesthetically pleasing effect. A cover plate can also be positioned adjacent to the top surface of the top clamp so that, for example, when a lamp is used as the accessory, a symmetrical effect is achieved.

According to another aspect, the invention is directed to a method for mounting an accessory to a support member comprising providing an adjustable clamping device wherein the clamping device defines a gap and a clamp nut assembly is associated with the clamping device. The clamp nut assembly includes a pivotally mounted tightening member adapted for pivoting between a first position and a second position. The method further comprises placing the clamping device about the edge of the support member, pivoting the tightening member to the first position for tightening the clamping device about the edge of the support member, providing an accessory sleeve, pivoting the tightening member to the second position such that the clamp nut assembly including the tightening member can receiving the accessory sleeve, and mounting the accessory to the accessory sleeve. According to one embodiment, the adjustable clamping device can comprises a foot base, a first rod extending from a surface of the foot base, a top clamp having at least a first aperture extending therethrough wherein the first aperture is configured for receiving the first rod. The clamp nut assembly is configured for cooperating with the first rod to adjust the gap between the foot base and the top clamp and the adjustable gap is configured for receiving the edge of the support member. The clamp nut assembly further includes a longitudinal member and the method includes pivoting the tightening member to the first position wherein the tightening member forms a T-shape with respect to the longitudinal member to tighten the clamping device about the edge surface and then after tightening, pivoting the tightening member to the second position such that it is in alignment with the longitudinal member enabling receipt of the accessory sleeve. The accessory can be a lamp, a divider, a panel, a computer monitor, a shelf, and the like.

These and other features and characteristics of the present invention, as well as the methods of operation and functions of the related elements of structures, and the combination of parts and economies of manufacture will become more apparent upon consideration of the following description with reference to the accompanying drawings, all of which form a part of this specification, wherein like reference numerals designate corresponding parts in the various figures.

### BRIEF DESCRIPTION OF THE DRAWINGS

FIG. 1 shows a perspective view of the fastening system of the invention;

FIG. 2 shows a side view of the fastening system of FIG. 1 connected to the edge portion of a support surface;

FIG. 3 shows an exploded perspective view of the fastening system of FIG. 1;

FIG. 4 shows an exploded view of a pair of fastening systems and a divider;

FIG. 5 shows a side view of the divider fastening system of FIG. 4;

FIG. 6 shows a front view of the pair of fastening systems of FIG. 4 for mounting the divider to a support surface;

FIG. 7 shows a perspective view of the fastening system of FIG. 1 including a lamp accessory mounted thereon; and

FIG. 8 shows a back perspective view of the fastening system of FIG. 1 including a panel or shelf accessory and computer monitor mounted thereon.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

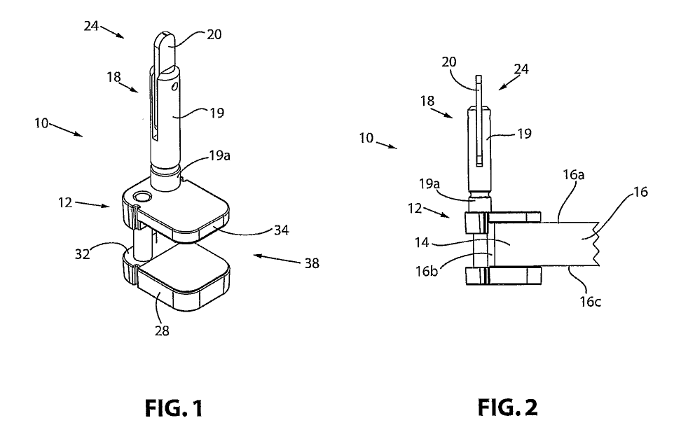

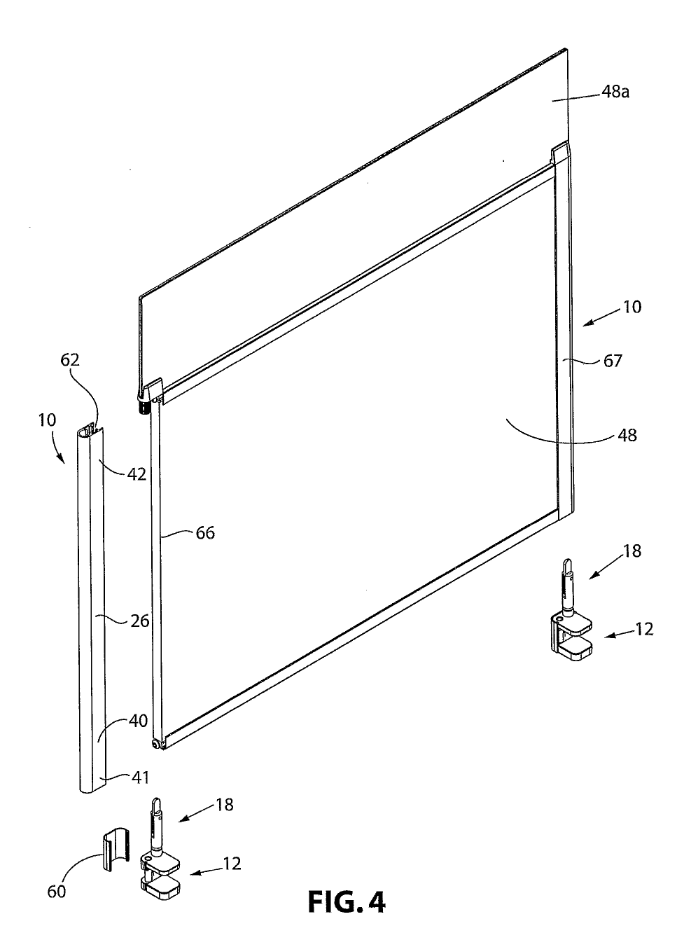

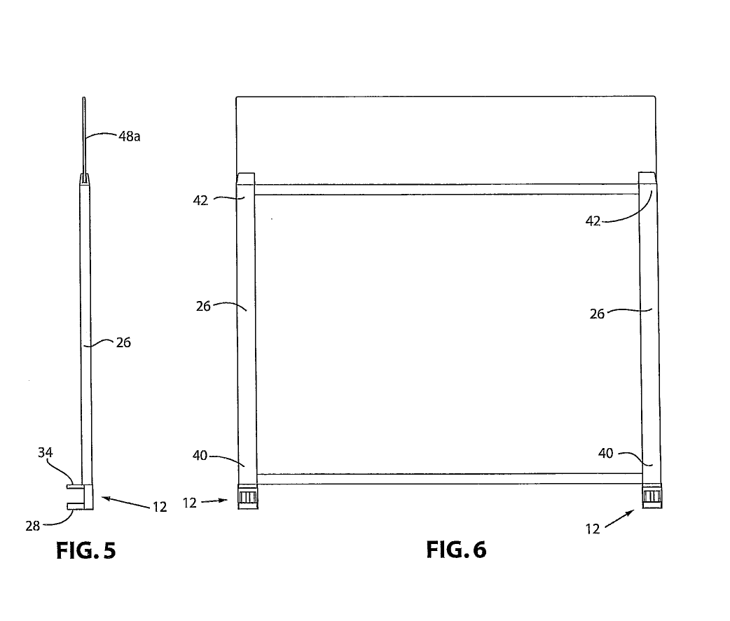

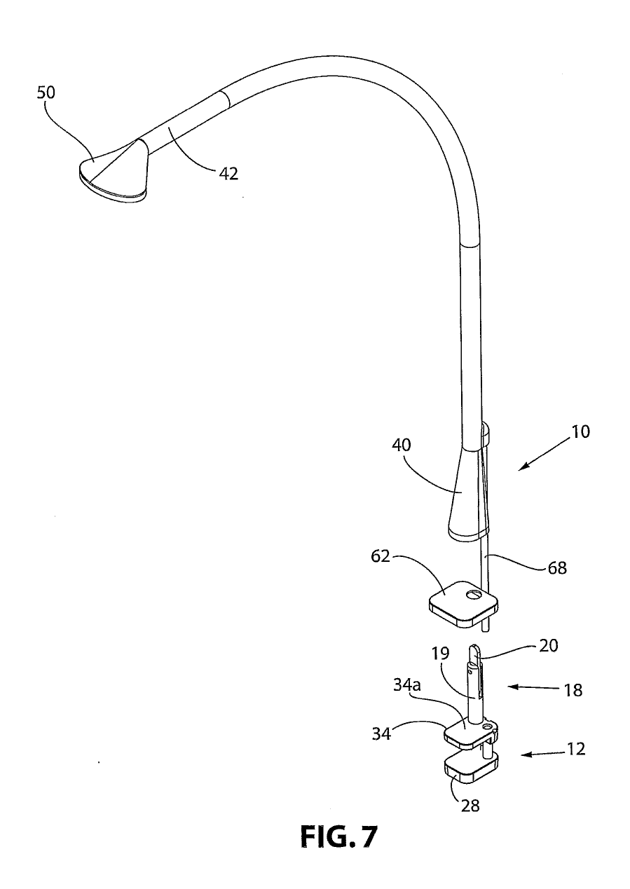

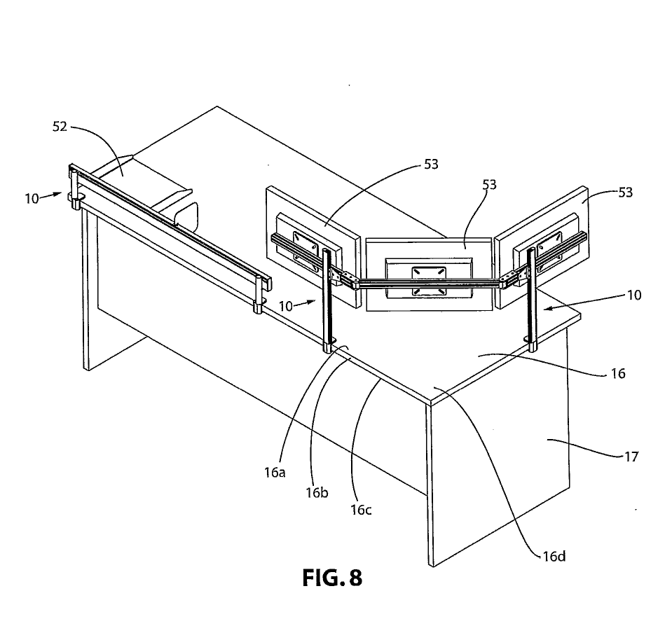

Reference is now made to FIGS. 1-3 which show the accessory mounting or fastening system, generally indicated as 10, of the invention. The fastening system 10 can be used for securing an accessory to the edge portion 14 of a support member 16, such as, for example a desk 17, as shown in FIG. 8. This accessory can be a divider or privacy screen 48, with or without a screen extender 48a, as shown in FIGS. 4-6, a lamp 50, as shown in FIG. 7, a shelf 52, or computer monitor 53, as shown in FIG. 8 or any other type of accessory that one would mount to a support member 16. Returning to FIGS. 1-3, the support member 16 has a top surface 16a, an end 16b, and a bottom surface 16c. The fastening system 10 of the invention is designed such that it is easy to clamp to the edge portion 14 of the support surface 16 and it is easy to access and manipulate the clamp nut assembly 18 from above the top surface 16a of the support member 16. This easy access allows one to move, adjust or remove the fastening system 10 and accessory without having to move the support member 16, such as the desk, away from the wall, or without having to crawl beneath the support member 16 to unclamp the fastening system 10. The fastening system 10 also does not require a tool for tightening or loosening the system 10.

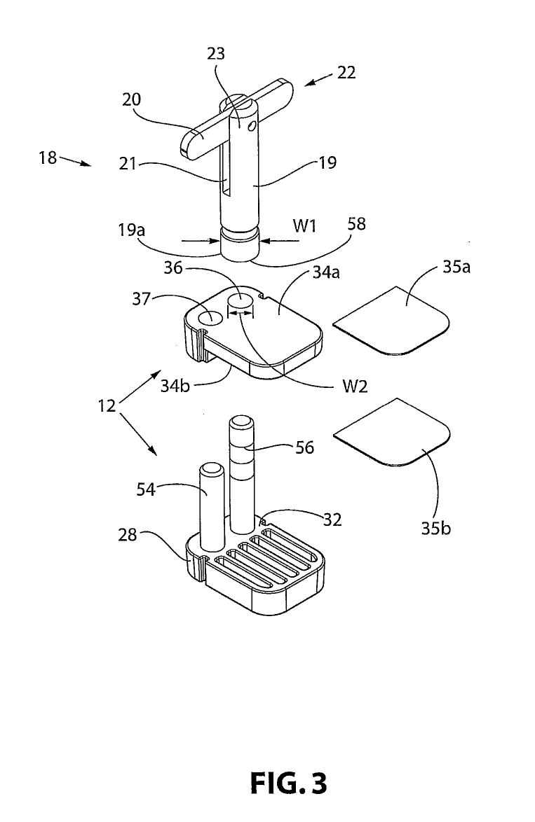

The fastening system 10 comprises a clamping device, generally indicated as 12 comprising foot base 28, a first rod 30 extending from an upper surface 32 of the foot base 28, a top clamp 34 having a top surface 34a and a bottom surface 34b. Adhesive backed neoprene pads 35a, 35b can be provided adjacent the top surface 34a and the bottom surface 34b, respectively. The top clamp 34 includes at least a first aperture 36 extending therethrough wherein the first aperture 36 is configured for slidingly receiving the first rod 30. The fastening system 10 further includes a clamp nut assembly, generally indicated as 18 configured for cooperating with the first rod 30 to form an adjustable gap 38 between the foot base 28 and the top clamp 34. The adjustable gap 38 is configured for receiving an edge portion 14 of the support member 16. The clamp nut assembly 18 further includes a tightening member 20 adapted for pivoting between a first position 22, as shown in FIG. 3, and a second position 24, as shown in FIGS. 1-2, wherein, when in the first position 22, the pivotal member has protruding wings which allow for ease of rotation of the clamp nut assembly 18 for adjustment of the gap 38 between the foot base 28 and the top clamp 34 such that the top clamp 34 frictionally engages the top surface 16a of the support member 16 and the foot base 28 frictionally engages the bottom surface 16c of the support member 16.

The fastening system 10 further includes an accessory sleeve 26, as shown in FIGS. 4-8, having a first end 40 configured for cooperation with the clamp nut assembly 18 and a second end 42 configured for holding or mounting the accessory 48, 50, 52, 53. This configuration on the second end 42 of the accessory sleeve 26 for holding the accessory can be a U-shape member, a clip, a screw/aperture arrangement, or any other well know arrangement for securing an accessory thereto.

According to one embodiment, as shown in FIG. 3, the foot base 28 can include a second rod 54 extending from the surface 32 thereof in a spaced relationship with respect to the first rod 30. This second rod 54 can extend through, or only partially through, a second aperture 37 in the top clamp 34. This second rod 54 provides for a more stable attachment of the clamping device 12 about the edge portion 14 of the support member 16.

Still referring to FIG. 3, the first rod 30 can include threads 56 and the clamp nut assembly 18 can include a threaded tubular portion 58 for threadedly and rotatably engaging the first rod 30. The base 19a of the longitudinal member 19 has a width W1 greater than the width W2 of the aperture 36 such that with the threaded first rod 30 extending through the aperture 36, the longitudinal member 19 engages the first rod 30 and is rotated against the top surface 34a of the top clamp 34 to adjust the gap 38 between the top clamp 34 and the foot base 32 to accommodate the thickness of the edge portion 14.

The clamp nut assembly 18 can comprise a longitudinal member 19 and the tightening member 20 is pivotally attached to the longitudinal member 19. This pivotal attachment of the tightening member 20 can be located at a top portion 23 of the longitudinal member 19. The tightening member 20 can pivot to the first position 22 (FIG. 3) extending in a transverse direction with respect to the longitudinal member 19 to enable tightening of the clamp nut assembly 18 from above the support surface 16a and without a tool. According to one design, the tightening member 20 can form a T-shape with respect to the longitudinal member 19 when in the first position 22. After tightening, the tightening member 20 can pivot to the second position 24 in line with the longitudinal member 19 enabling the accessory sleeve 26 to fit over at least a portion of the longitudinal member 19.

According to one embodiment, the longitudinal member 19 can include an opening 21 for receiving the tightening member 20 when the tightening member 20 is in the second position 24. This opening 21 allows the tightening member 20 to fit itself within the envelope of the longitudinal member 19 to produce a planar or cylindrical outer surface such that the accessory sleeve 26 easily fits over the longitudinal member 19.

Directing attention to FIGS. 4-8, according to one design, the accessory sleeve 26 can be a tubular member wherein the first end 40 is adapted for fitting about and enclosing the longitudinal member 19. This type of design would be suitable for holding a longitudinally extending accessory, such as a lamp 50, as shown in FIG. 7. In this design, the accessory mounting sleeve 26 can be a lamp base receiver and an electric cord 68 can extend from a back surface of the lamp base receiver.

According to another design, as shown in FIG. 4, the accessory sleeve 26 can be a U-shaped member having an opening 64 for receiving one edge portion 66 of the accessory, such as edge portion 66, 67 of the divider 48. In this design, a second fastening system 10 may be provided to sufficiently anchor the divider 48 to the support member 16 at the other edge portion 67 of the divider 48. According to yet another design, as shown in FIG. 8, at least two fastening systems 10 may be used at any location, i.e. such as on two sides adjoining sides of a support member 16, so that an accessory or accessories 53 such as a computer monitor or a plurality of computer monitors 53 can straddle the corner 16d of the support member 16.

As illustrated in FIG. 1, in the clamped position, the rear of the fastening system 10 is exposed such that the first rod 30 (FIG. 3) and the second rod 54 are visible. For aesthetics, a cover plate 60, as shown in FIG. 4 can be provided to cover at least one side of the adjustable opening 38 extending between the foot base 28 and the top clamp 34, such as the back opening, so that from the rear, the first threaded rod 30 and the second rod 54 are not visible, thus producing an aesthetically pleasing effect. A top cover plate 62, as shown in FIG. 7 can also be positioned adjacent to the top surface 34a of the top clamp 34 so that, for example, when lamp 50 is used as the accessory, the second aperture 37 (FIG. 3) is hidden.

The invention is also directed to a method for mounting an accessory to a support member 16. The method comprises providing an adjustable clamping device 12 wherein the clamping device defines a gap 38 and a clamp nut assembly 18 is associated therewith. The clamp nut assembly 18 includes a pivotally mounted tightening member 20 adapted for pivoting between a first position 22 and a second position 24. The method further comprises placing the clamping device 12 about the edge 14 of the support member 16, such as a desk as shown in FIG. 8, and pivoting the tightening member 20 to the first position 22, so as to form a T-shape, as discussed above, to enable a user to tighten the clamping device 12 about the edge 14 of the support member 16. The method also comprises providing an accessory sleeve 26, pivoting the tightening member 20 to the second position 24 such that the clamp nut assembly 18 including the tightening member 20 can receive the accessory sleeve 26 thereon, and mounting the accessory to the accessory sleeve 26. It is recognized that the accessory can be mounted to the accessory sleeve before or after placement of the accessory sleeve 26 onto the clamp nut assembly 18. As shown in FIGS. 4-8, the accessory can be a divider 48, a lamp 50, a shelf 52, a computer screen 53 or any type of accessory which one would wish to mount onto a support member 16 or desk.

As stated above and shown particularly in FIG. 3, the adjustable clamping device can comprise a foot base 28, a first rod 30 extending from a surface 32 of the foot base 28, a top clamp 34 having at least a first aperture 36 extending therethrough wherein the first aperture 36 is configured for receiving the first rod 30. The clamp nut assembly 18 is configured for cooperating with the first rod 30 to adjust the gap 38 between the foot base 28 and the top clamp 34 and the adjustable gap 38 is configured for receiving the edge 14 of the support member 16. The clamp nut assembly 18 further includes a longitudinal member 19 and the method includes pivoting the tightening member 20 to the first position 22 wherein the tightening member forms a T-shape with respect to the longitudinal member 19 to tighten the clamping device 12 about the edge surface 14 and then after tightening, pivoting the tightening member 20 to the second position 24 such that it is in alignment with the longitudinal member 19 enabling receipt of the accessory sleeve 26. The accessory can be a divider 48, such as a privacy screen, a computer screen or a plurality of computer screens 53, a lamp 50, a shelf 52, and the like.

Although the invention has been described in detail for the purpose of illustration based on what is currently considered to be the most practical and preferred embodiments, it is to be understood that such detail is solely for that purpose and that the invention is not limited to the disclosed embodiments, but on the contrary, is intended to cover modifications and equivalent arrangements that are within the spirit and scope of the invention. For example, it is to be understood that the present invention contemplates that, to the extent possible, one or more features of any embodiment can be combined with one or more features of any other embodiment.

The invention claimed is:

1. An accessory fastening system comprising:
an adjustable clamping device for frictionally engaging an edge portion of a support member;
a clamp nut assembly associated with the clamping device, said clamp nut assembly including a tightening member adapted for pivoting movement between a first and second position; and
an accessory sleeve configured for mounting upon the clamp nut assembly, wherein said tightening member pivots between the first position to enable adjustment of the clamping device into frictional engagement with the support member and the second position wherein the clamp nut assembly is configured for receiving the accessory sleeve.

2. The accessory mounting system of claim 1 wherein the adjustable clamping device comprises a foot base, a first rod extending from a surface of the foot base, a top clamp having at least a first aperture extending therethrough, said first aperture configured for receiving said first rod, and said clamp nut assembly configured for cooperating with the first rod to form an adjustable gap between said foot base and said top clamp, said adjustable gap configured for receiving an edge of said support member.

3. The accessory mounting system of claim 1 wherein the clamp nut assembly includes a longitudinal member and the tightening member forms a T-shape with respect to the longitudinal member when in said first position.

4. The accessory mounting system of claim 3 wherein the tightening member is in alignment with the longitudinal member when in said second position enabling receipt of the accessory sleeve.

5. The accessory mounting system of claim 4 wherein the accessory sleeve has a first end and a second end and wherein said first end includes an opening for receiving at least a portion of the clamp nut assembly when said tightening member is in the second position and said second end includes a mounting member configured for holding an accessory.

6. The accessory mounting system of claim 4 wherein the longitudinal member includes an opening for receiving the tightening member when said tightening member is in said second position.

7. The accessory mounting system of claim 5 wherein the accessory is selected from the group consisting of a lamp, a divider, a panel, a computer monitor and a shelf.

8. A fastening system for securing an accessory to a support member, said support member having a top surface, an end portion, and a bottom surface, said fastening system comprising
(a) a clamping device comprising:
foot base;
a first rod extending from a surface of the foot base;
a top clamp having a top surface and a bottom surface, said top clamp including at least a first aperture extending therethrough, said first aperture configured for receiving said first rod;
(b) a clamp nut assembly configured for cooperating with the first rod to form an adjustable gap between said foot base and said top clamp, said adjustable gap configured for receiving said support member, the clamp nut assembly including a tightening member adapted for pivoting between a first position and a second position, said first position allowing adjustment of the gap between the foot base and the top clamp such that the top clamp frictionally engages the top surface of the support member and the foot base frictionally engages the bottom surface of the support member; and
(c) an accessory sleeve having a first end configured for cooperation with the clamp nut assembly when said pivotal member is in said second position, said accessory sleeve having a second end configured for holding the accessory.

9. The fastening system of claim 8 wherein the foot base includes a second rod extending from the surface thereof in a spaced relationship with respect to the first rod.

10. The fastening system of claim 8 wherein the first rod includes threads and the clamp nut assembly includes a threaded tubular portion for threadedly engaging the first rod.

11. The fastening system of claim 8 wherein the clamp nut assembly further comprises a longitudinal member and the tightening member is pivotally attached to the longitudinal member.

12. The fastening system of claim 11 wherein the tightening member pivots between a first position extending in a transverse direction with respect to the longitudinal member to enable tightening of the clamp nut assembly and a second position in line with the longitudinal member enabling receipt of the accessory sleeve onto at least a portion of the clamp nut assembly.

13. The fastening system of claim 12 wherein the longitudinal member includes an opening for receiving the tightening member when said tightening member is in the second position.

14. The fastening system of claim 8 including a cover plate extending between the foot base and the top clamp to cover at least one side of the opening extending between the foot base and the top clamp.

15. The fastening system of claim 8 including a top cover plate positioned adjacent to the top surface of the top clamp.

16. The fastening system of claim 8 wherein the accessory is selected from the group consisting of a lamp, a divider, a panel, a computer monitor and a shelf.

17. A method for mounting an accessory to a support member comprising:
providing an adjustable clamping device, said clamping device defining a gap and having a clamp nut assembly associated therewith, said clamp nut assembly including a pivotally mounted tightening member adapted for pivoting between a first position and a second position;
placing said clamping device about the edge portion of the support member;
pivoting the tightening member to said first position to tighten said clamping device about the edge of said support member;
providing an accessory sleeve;
pivoting the tightening member to said second position such that the clamp nut assembly is configured for receiving the accessory sleeve; and
mounting the accessory to the accessory sleeve.

18. The method of claim 17 wherein the adjustable clamping device comprises a foot base, a first rod extending from a surface of the foot base, a top clamp having at least a first aperture extending therethrough, said first aperture configured for receiving said first rod, and the clamp nut assembly configured for cooperating with the first rod to adjust the gap between said foot base and said top clamp, said adjustable gap configured for receiving said edge of said support member.

19. The method of claim 17 wherein the clamp nut assembly further includes a longitudinal member and the method includes pivoting the tightening member to the first position wherein the tightening member forms a T-shape with respect to the longitudinal member to enable tightening of the clamping device and pivoting the tightening member to the second position after tightening such that the tightening member is in alignment with the longitudinal member enabling receipt of the accessory sleeve.

20. The method of claim 17 wherein the accessory is selected from the group consisting of a lamp, a divider, a panel, a computer monitor and a shelf.
